(19) United States
(12) Patent Application Publication
(10) Pub. No.: US 2019/0049776 A1
(43) Pub. Date: Feb. 14, 2019

(54) LIGHT TRANSMISSION DIRECTION CONTROL SHEET

(71) Applicant: SHIN-ETSU POLYMER CO., LTD., Tokyo (JP)

(72) Inventor: Susumu Iwama, Shiojiri-Shi (JP)

(21) Appl. No.: 15/672,067

(22) Filed: Aug. 8, 2017

(51) Int. Cl. G02F 1/1335; F21V 11/02; F21V 14/08; B32B 7/12; F21V 8/00; G02B 5/00; G02B 5/02; E06B 9/24; G02B 5/22; C08G 18/16

(52) U.S. Cl. CPC G02F 1/133502; F21V 11/02; F21V 14/08; B32B 7/12; G02B 6/0025; G02B 2207/123; G02B 5/0268; E06B 9/24; G02B 5/223; C08G 18/16; G02B 5/003

(57) ABSTRACT

A light transmission direction control sheet includes a louver layer having a light transmission band and a light-shielding band alternately and repeatedly disposed, a first transparent resin layer disposed on a first surface of the louver layer, and a second transparent resin layer disposed on a second surface of the louver layer. Each of the difference between the refractive index of the light transmission band and the refractive index of the first transparent resin layer, and the difference between the refractive index of the light transmission band and the refractive index of the second transparent resin layer, is less than 0.1.

### BACKGROUND OF THE INVENTION

### Field of the Invention

The present invention relates to a light transmission direction control sheet through which only a light ray having a specific incident angle in a bundle of incident light rays passes. More specifically, the present invention relates to a light transmission direction control sheet capable of realizing a narrow viewing angle when the light transmission direction control sheet is disposed on a display screen or the like of lighting and various information display devices.

### Description of Related Art

A peeping prevention body disposed on a display screen of an information display device such as a portable information terminal, an automatic teller machine, or the like, and capable of preventing peeping from left and right sides and an opposite side without deteriorating visibility from a front side of the display screen is disclosed (JP 3675752 B2). This peeping prevention body has a three-layer structure in which an antiglare layer having a light transmission band and a light-shielding band alternately disposed, a light-transmitting sticking layer disposed on one surface of the antiglare layer, and a light-transmitting layer disposed on the other surface of the antiglare layer on the opposite side to the sticking layer are laminated. The sticking layer is stuck to the display screen of the information display device to be used.

There is a need to enhance user's convenience by incorporating a light transmission direction control sheet (peeping prevention body) into a portable information terminal. The light-transmitting layer disposed in the peeping prevention body of JP 3675752 B2 has a sufficient thickness for the purpose of enhancing rigidity of the peeping prevention body, and therefore is not suitable for use for incorporation into a narrow terminal. For the purpose of thinning, when the light-transmitting layer of the peeping prevention body is removed, minute unevenness inevitably formed on a surface of the antiglare layer during manufacturing is exposed. This unevenness causes irregular reflection of light. Therefore, the haze value becomes high, an image passing through the antiglare layer cannot be clearly visually recognized, and the antiglare layer itself cannot be clearly visually recognized disadvantageously.

If this peeping prevention body is bonded to the display screen, the irregular reflection of light can be suppressed, but it is difficult to see through the peeping prevention body before bonding. Therefore, it may be difficult to perform quality inspection of the peeping prevention body disadvantageously.

In addition, in a conventional peeping prevention body, the refractive index of a transparent resin constituting a light-transmitting layer is different from the refractive index of a transparent resin constituting an anti-glare layer, and therefore the light transmittance may be lowered due to the difference in refractive index.

### SUMMARY OF THE INVENTION

The present invention has been achieved in view of the above circumstances, and an object of the present invention is to provide a light transmission direction control sheet having an excellent light transmittance and capable of performing quality inspection visually.

[1] A light transmission direction control sheet including: a louver layer having a light transmission band and a light-shielding band alternately and repeatedly disposed; a first transparent resin layer disposed on a first surface of the louver layer; and a second transparent resin layer disposed on a second surface of the louver layer, in which each of the difference between the refractive index of the light transmission band and the refractive index of the first transparent resin layer, and the difference between the refractive index of the light transmission band and the refractive index of the second transparent resin layer, is less than 0.1.

[2] The light transmission direction control sheet according to [1], in which an arithmetic average roughness (Ra) of at least one of an outer surface of the first transparent resin layer and an outer surface of the second transparent resin layer is 0 μm to 3.0 μm.

[3] The light transmission direction control sheet according to [1], in which the light transmission band, the first transparent resin layer, and the second transparent resin layer are formed of a silicone rubber.

[4] The light transmission direction control sheet according to [2], in which the light transmission band, the first transparent resin layer, and the second transparent resin layer are formed of a silicone rubber.

[5] The light transmission direction control sheet according to any one of [1] to [4], in which a thickness of the louver layer is 150 μm to 500 μm, a thickness of the first transparent resin layer is 10 μm to 20 μm, and a thickness of the second transparent resin layer is 10 μm to 20 μm.

A light transmission direction control sheet according to an aspect of the present invention has an excellent light transmittance because interface reflection at an interface between the louver layer and each of the first and second transparent resin layers is reduced. As a result, it is possible to suppress reduction in luminance of a disposed display screen and to obtain a sufficiently bright display screen even when the backlight luminance is set to a low value. In addition, it is possible to reduce power consumption of a backlight. Furthermore, quality inspection can be easily performed visually due to the excellent light transmittance. These excellent effects can be exhibited sufficiently even when the light transmission direction control sheet according to an aspect of the present invention is thinned, and therefore the light transmission direction control sheet can be easily incorporated into an information display device.

### BRIEF DESCRIPTION OF THE DRAWINGS

FIG. 1 is a cross-sectional view showing an example of a light transmission direction control sheet according to an aspect of the present invention; and

FIG. 2 is a perspective view showing another example of the light transmission direction control sheet according to an aspect of the present invention.

### DETAILED DESCRIPTION OF THE INVENTION

As shown in FIG. 1, a light transmission direction control sheet 10 according to an aspect of the present invention includes a louver layer 1 having a light transmission band 2 and a light-shielding band 3 alternately and repeatedly disposed, a first transparent resin layer 4 disposed on a first surface of the louver layer 1, and a second transparent resin layer 5 disposed on a second surface of the louver layer 1.

The light transmission bands 2 and the light-shielding bands 3 are formed in a thickness direction of the louver layer 1. In other words, the light transmission bands 2 and the light-shielding bands 3 are alternately and repeatedly disposed in a width direction (direction orthogonal to the thickness direction) of the louver layer 1. In the louver layer 1, light is transmitted through the light transmission band 2 sandwiched by the light-shielding bands 3 in the thickness direction of the louver layer 1, that is, in the thickness direction of the light transmission direction control sheet 10.

In the light transmission direction control sheet 10, the first surface of the louver layer 1 supports a first main surface of the sheet, the second surface of the louver layer 1 supports a second main surface of the sheet, and the first surface and the second surface face each other.

The size of the light transmission direction control sheet 10 is not particularly limited, but may be, for example, a rectangular size having a length of 1 mm to 1500 mm and a width of about 1 mm to 1500 mm in a plan view. The thickness of the light transmission direction control sheet 10 will be described below.

In the light transmission direction control sheet 10, each of a difference between the refractive index of the light transmission band 2 and the refractive index of the first transparent resin layer 4, and a difference between the refractive index of the light transmission band 2 and the refractive index of the second transparent resin layer 5, is less than 0.1. Here, the difference between the refractive indices is an absolute value.

In the present disclosure, the “refractive index” is the refractive index of a member with respect to the vacuum and means an absolute refractive index. This refractive index is determined in accordance with method A of JIS K 7142: 2014 (ISO 489: 1999) “How to determine plastic-refractive index”.

The difference between the refractive index of the light transmission band 2 and the refractive index of the first transparent resin layer 4 is less than 0.1, preferably less than 0.01, and more preferably substantially zero. This reduces interface reflection at an interface between the louver layer 1 and the first transparent resin layer 4 and improves a light transmittance. Similarly, the difference between the refractive index of the light transmission band 2 and the second transparent resin layer 5 is less than 0.1, preferably less than 0.05, more preferably less than 0.02, and most preferably substantially zero. This reduces interface reflection at an interface between the louver layer 1 and the second transparent resin layer 5 and improves a light transmittance. As a result, the light transmission direction control sheet 10 has an excellent light-transmitting property.

When a surface of the louver layer 1 is exposed without a transparent resin layer being disposed, irregular reflection of light occurs on the exposed surface, and therefore it is difficult to visually confirm that the light transmission band 2 and the light-shielding band 3 constituting the louver layer 1 are arranged regularly through the louver layer 1. Meanwhile, by disposing the first transparent resin layer 4 and the second transparent resin layer 5, it is possible to visually confirm that the light transmission band 2 and the light-shielding band 3 constituting the louver layer 1 are arranged regularly by seeing through the light transmission direction control sheet 10. This makes it possible to perform quality control easily.

The arithmetic average roughness (Ra) of at least one of an outer surface (surface facing an outside) 4a of the first transparent resin layer 4 and an outer surface 5a of the second transparent resin layer 5 is preferably 0 μm to 3.0 μm, more preferably 0.0 μm to 0.5 μm, and still more preferably 0.0 μm to 0.2 μm.

Within the above range, the outer surface has a smoothness equal to a mirror finished surface, and scattering of light on the outer surface is further suppressed. This makes it easier to visually confirm that the light transmission band 2 and the light-shielding band 3 constituting the louver layer 1 are regularly arranged through the first transparent resin layer 4 and the second transparent resin layer 5. That is, quality control can be performed more easily. Furthermore, an optical characteristic such as a light-transmitting property of the light transmission direction control sheet 10 can be improved.

Note that here, a numerical range of “lower limit value to upper limit value” means a numerical range of “lower limit value or more and upper limit value or less” unless otherwise specified.

The arithmetic average roughness (Ra) of each of the outer surface 4a of the first transparent resin layer 4 and the outer surface 5a of the second transparent resin layer 5 is preferably within the above preferable range from a viewpoint of improving transparency of the light transmission direction control sheet 10.

In the present invention, the “arithmetic average roughness (Ra)” is determined in accordance with JIS B 0601: 2013 (ISO 4287: 1997) “geometric characteristic specification of product”.

[Material of Light Transmission Band]

A material of the light transmission band 2 constituting the louver layer 1 is not particularly limited as long as it satisfies the above relationship with the refractive index, and for example, is suitably a resin having high transparency. Specifically, a resin material having high transparency, for example, a resin material having a light transmittance (light ray transmittance) of 75% or more, preferably 85% or more when light passes through only the light transmission band 2 of the louver layer 1 in the thickness direction of the louver layer 1, is preferable. In addition, the upper limit value of the light transmittance is not particularly limited, and can be set to, for example, 99.99% or less. As the resin material, for example, a thermoplastic resin or a thermosetting resin having high transparency is used, and specific examples thereof include a cellulose resin, a polyolefin resin, a polyester resin, a silicone resin, a polystyrene resin, a polyvinyl chloride resin, an acrylic resin, and a polycarbonate resin. Among the resins, a silicone resin is preferable, and a silicone rubber is particularly preferable from a viewpoint of heat resistance. The silicone rubber may be a composition containing a component other than the silicone resin.

Examples the silicone rubber include a silicone rubber composition generally called a millable rubber, formed of a diorganopolysiloxane having a molecular chain terminal blocked with a hydroxysilyl group or a vinylsilyl group and an organic peroxide; and a so-called addition reaction type organosilicone rubber composition obtained by blending an organohydrogenpolysiloxane having at least three hydrogen atoms bonded to silicon atoms (═SiH bonds) in a molecule thereof and a platinum catalyst to a diorganopolysiloxane having at least two vinyl groups bonded to silicon atoms in a molecule thereof.

[Material of Light-Shielding Band]

A material of the light-shielding band 3 constituting the louver layer 1 is not particularly limited, and preferable examples thereof include a colored resin obtained by adding a coloring agent such as a pigment or a dye to a base material formed of the resins listed above as a material of the light transmission band 2. The resin material forming the light transmission band 2 and the resin material as a base material of the light-shielding band 3 may be the same as or different from each other. However, these resin materials are preferably the same as each other from a viewpoint that good adhesiveness between the light transmission band 2 and the light-shielding band 3 is easily obtained.

The color tone of the light-shielding band 3 only needs to obtain a sufficient light-shielding property, and examples thereof include black, red, yellow, green, blue, and light blue. The color tone and the light shielding property of the light-shielding band 3 can be adjusted by the kind of a coloring agent and the addition amount thereof. Specifically, when only the light-shielding band 3 of the louver layer 1 is irradiated with light in the thickness direction of the louver layer 1, the light-shielding band 3 preferably has a light transmittance of 20% or less, preferably 5% or less. The light transmittance may be 0%. In addition, the color tone of the light-shielding band 3 is a color tone recognized when the louver layer 1 is viewed, and therefore design is preferably performed in consideration of decorativeness.

Specific examples of the coloring agent include general organic and inorganic pigments such as carbon black, iron oxide, titanium oxide, yellow iron oxide, disazo yellow, and phthalocyanine blue. The coloring agents may be used singly or in combination of two or more kinds thereof. In a case where a black pigment is not used, a white pigment is preferably used in combination with another color pigment in order to obtain a good light-shielding property.

[Widths of Light Transmission Band and Light-Shielding Band]

The widths (thicknesses in the horizontal direction in FIG. 1) of the light transmission band 2 and the light-shielding band 3 are freely set. The light transmittance of the louver layer 1 can be adjusted by a ratio of the width of the light transmission band 2/the width of the light-shielding band 3. The range of a viewing angle (visible angle) can be adjusted by the width of the light transmission band 2 and the thickness of the louver layer 1.

In consideration of obtaining both prevention of peeping and satisfactory visibility of a display screen, the width of the light transmission band 2 is preferably 50 to 200 μm, and more preferably 100 to 150 μm. The width of the light-shielding band 3 is preferably 1 to 50 μm, and more preferably 10 to 30 μm. When each width is adjusted within the above range, for example, the light transmission direction control sheet 10 having a light transmittance of 80% or more and a viewing angle of 30 to 120° is obtained.

A ratio represented by the width of the light-shielding band 3/the width of the light transmission band 2 is preferably 0.005 to 1, and more preferably 0.06 to 0.3.

[Material of Transparent Resin Layer]

Materials of the first transparent resin layer 4 and the second transparent resin layer 5 are not particularly limited as long as they satisfies the above relationship with the refractive index, and the resins described above as a material of the light transmission band 2 are suitable, for example. A material having a light transmittance of 75% or more in the thickness direction of each transparent resin layer is preferable, and a material having a light transmittance of 85% or more in the thickness direction of each transparent resin layer is more preferable. The upper limit of the light transmittance is not particularly limited, and can be 99.99% or less, for example.

Specific examples of the transparent resin layer include a cellulose resin, a polyolefin resin (particularly, a cycloolefin polymer), a polyester resin, a silicone resin, a polystyrene resin, a polyvinyl chloride resin, an acrylic resin, and a polycarbonate resin. Examples of a suitable silicone rubber include those exemplary examples above for the light transmission band.

Among the above compounds, a silicone resin (refractive index=1.43) having a refractive index closer to the refractive index of air (1.0003) than a thermoplastic resin such as polycarbonate or PET (refractive index=1.59 to 1.60) and having less loss in light transmittance due to interface reflection is preferable, and a silicone rubber (refractive index=1.40 to 1.43) is more preferable from a viewpoint of heat resistance. When the transparent resin layers 4 and 5 are formed of a silicone rubber, adhesiveness of the outer surfaces 4a and 5a of the transparent resin layers 4 and 5 is remarkably improved (tackiness can be imparted). Therefore, the light transmission direction control sheet 10 can be easily disposed on a surface of a display screen while the transparent resin layers 4 and 5 are in close contact with the surface of the display screen.

A resin constituting each transparent resin layer may contain a known additive in the field of a resin film, such as an ultraviolet absorber, an infrared absorber, or a coloring agent, if necessary, in order to improve weather resistance, to improve design properties, and the like.

A material of the first transparent resin layer 4 and a material of the second transparent resin layer 5 may be the same as or different from each other, but are preferably the same from a viewpoint of easily satisfying the above relationship with the refractive index. Materials of the first transparent resin layer 4 and the second transparent resin layer 5 are preferably the same as a material of the light transmission band 2 of the louver layer 1 from the same viewpoint.

[Thickness of Each Layer]

The thickness of the louver layer 1 is preferably 100 μm to 5000 μm, more preferably 150 μm to 1000 μm, and still more preferably 150 μm to 500 μm. When the thickness of the louver layer 1 is within the above range, control of a viewing angle (visible angle) is easy.

The thicknesses of the first transparent resin layer 4 and the second transparent resin layer 5 are each independently preferably 1 μm to 100 μm, more preferably 5 μm to 50 μm, and still more preferably 10 μm to 20 μm. When each of the thicknesses of the first transparent resin layer 4 and the second transparent resin layer 5 is within the above ranges, rigidity and thinning of the light transmission direction control sheet 10 can be balanced.

The total thickness of the louver layer 1, the first transparent resin layer 4, and the second transparent resin layer 5 is preferably 100 μm to 5200 μm, more preferably 150 μm to 1200 μm, and still more preferably 200 μm to 700 μm.

When the total thickness of the layers is not less than the lower limit value of the above range, rigidity of the light transmission direction control sheet 10 is increased, operability when the light transmission direction control sheet 10 is disposed near a display screen of an information display device is improved, and a viewing angle (visible angle) can be easily controlled.

When the total thickness of the layers is not more than the upper limit value of the above range, the light transmission direction control sheet 10 can be sufficiently thinned and can be easily incorporated into an information display device.

Note that here, “thickness” is a value obtained by observing a cross section of an object to be measured using a microscope, measuring thicknesses at five places, and averaging the thicknesses.

[Optional Transparent Member]

An optional transparent member such as a transparent layer or a transparent film may be disposed on at least one of the outer surface 4a of the first transparent resin layer 4 and the outer surface 5a of the second transparent resin layer 5, and examples thereof include a known pressure-sensitive adhesive layer, adhesive layer, transparent film, and protective sheet.

Examples of a material of the pressure-sensitive adhesive layer include an elastomer pressure-sensitive adhesive, an acrylic pressure-sensitive adhesive, a urethane pressure-sensitive adhesive, and a rubber pressure-sensitive adhesive. Examples of the elastomeric pressure-sensitive adhesive include pressure-sensitive adhesives including a silicone rubber, a silicone gel, a urethane rubber, and a urethane gel. In a case of using an elastomer pressure-sensitive adhesive, a surface of a pressure-sensitive adhesive layer is preferably subjected to known mirror finishing in order to enhance transparency thereof.

The difference between the refractive index of the above optional transparent member such as a transparent layer or a transparent film and the refractive index of each constituent material of the light transmission band 2, the first transparent resin layer 4, and the second transparent resin layer 5 is preferably less than 0.1, more preferably less than 0.02, and preferably substantially zero from the viewpoint of making the optical characteristics of the light transmission direction control sheet 10 excellent.

In addition, preferably, another transparent member is not disposed on the outer surface of the first transparent resin layer 4 or the outer surface of the second transparent resin layer 5 from the viewpoints of making an optical characteristic of the light transmission direction control sheet 10 excellent and simplifying a sheet structure.

[Method For Manufacturing Light Transmission Direction Control Sheet]

The louver layer 1 constituting the light transmission direction control sheet 10 can be manufactured, for example, by the following method. First, a plurality of first sheets of a desired thickness formed of a constituent material of the light transmission band 2 and a plurality of second sheets of a desired thickness formed of a constituent material of the light-shielding band 3 are alternately laminated, heated, and pressurized to form a block body in which the plurality of sheets is integrated.

Subsequently, by slicing the block body with a cut plane perpendicular to a sheet surface, the louver layer 1 is obtained. The thickness (slice width) at the time of slicing corresponds to the thickness of the louver layer 1. By slicing the block body with a surface tilted with respect to the sheet surface, an angle formed by a surface of the louver layer 1 and the light-shielding band 3 can be adjusted.

A method for laminating and integrating the louver layer 1 and the transparent resin layers 4 and 5 is not particularly limited, and a known method can be appropriately used.

Examples thereof include a method for forming the first transparent resin layer 4 by applying a material forming the first transparent resin layer 4 on the first surface of the louver layer 1 and curing the material. The second transparent resin layer 5 can be formed on the second surface of the louver layer 1 by a similar method.

By laminating and integrating the louver layer 1 and the transparent resin layers 4 and 5, and molding the integrated laminate into a desired shape, the light transmission direction control sheet 10 is obtained. The planar shape of the light transmission direction control sheet 10 is not particularly limited, and it is only required to adopt a shape such as a rectangle, a polygon, a circle, or an ellipse appropriately according to the shape of a display screen to be disposed.

In the above, the case where the light transmission direction control sheet according to an aspect of the present invention includes one louver layer has been described. The light transmission direction control sheet according to an aspect of the present invention may include two louver layers. Hereinafter, a configuration of a light transmission direction control sheet 20 having two louver layers laminated will be described with reference to FIG. 2.

FIG. 2 is an enlarged perspective view schematically showing a part of the light transmission direction control sheet 20. In FIG. 2, a thickness direction of the light transmission direction control sheet 20 is defined as a Z direction, a light source side of light incident on the sheet 20 is defined as a Z1 side, and an irradiation side (viewing side) from which light passing through the sheet 20 is emitted is defined as a Z2 side. Two directions perpendicular to each other in a plane perpendicular to the Z direction are defined as X direction and a Y direction, respectively.

In the light transmission direction control sheet 20, in the thickness direction, in order from the Z1 side, a first transparent resin layer 21, a first louver layer 22, a third transparent resin layer 23, a second louver layer 24, and a second transparent resin layer 25 are laminated and are integrated with one another.

The first transparent resin layer 21 is disposed on a surface (first surface) on the Z1 side of the first louver layer 22. The second transparent resin layer 25 is disposed on a surface (second surface) on the Z2 side of the second louver layer 24. The third transparent resin layer 23 is disposed on a surface (second surface) on the Z2 side of the first louver layer 22, that is, on a surface (first surface) on the Z1 side of the second louver layer 24.

The entire planar shape of the light transmission direction control sheet in the X-Y plane (plane perpendicular to the Z direction) is, for example, a rectangle, but can be appropriately changed in accordance with the shape of a place where the light transmission direction control sheet is disposed.

In the light transmission direction control sheet 20, each of the difference between the refractive index of a light transmission band 26 and the refractive index of the first transparent resin layer 21, the difference between the refractive index of the light transmission band 26 and the refractive index of the third transparent resin layer 23, a difference between the refractive index of the third transparent resin layer 23 and the refractive index of a light transmission band 28, and a difference between the refractive index of the light transmission band 28 and the refractive index of the second transparent resin layer 25 is less than 0.1. Here, the difference between the refractive indices is an absolute value.

In the first louver layer 22, the light transmission band 26 and the light-shielding band 27 are alternately repeated in the Y direction. Both the light transmission band 26 and the light-shielding band 27 have belt-like shapes extending in the X direction, and widths thereof in the Y direction are uniform and constant. A plurality of the light transmission bands 26 have the same width, and a plurality of the light-shielding bands 27 have the same width.

In the second louver layer 24, the light transmission band 28 and a light-shielding band 29 are alternately repeated in the X direction. Both the light transmission band 28 and the light-shielding band 29 have belt-like shapes extending in the Y direction, and widths thereof in the X direction are uniform and constant. A plurality of the light transmission bands 28 have the same width, and a plurality of the light-shielding bands 29 have the same width.

In the light transmission direction control sheet 20 shown in FIG. 2, light-shielding bands are arranged such that an intersection angle of the light-shielding bands in the louver layers 22 and 24 laminated in two layers is about 90° in a plan view. Herein, the above intersection angle may be an angle other than 90°, or may be any angle selected from 0 to 90°. The thicknesses of the first louver layer 22 and the second louver layer 24 are set independently and may be the same as or different from one another. The widths of the light transmission band and the light-shielding band in the louver layers are set independently and may be the same as or different from one another.

The light transmission direction control sheet 20 of FIG. 2 has a configuration in which two of the light transmission direction control sheets 10 of FIG. 1 are stacked in two stages and the third transparent resin layer 23 is shared by the upper and lower light transmission direction control sheets 10. The difference in refractive index between each of the louver layers 22 and 24 and each of the transparent resin layers 21, 23, and 25 is as described above, and interface reflection at an interface between each louver layer and each transparent resin layer is thereby reduced, and a light transmittance is improved. As a result, the light transmission direction control sheet 20 has an excellent light-transmitting property. Furthermore, in the light transmission direction control sheet 20, the first louver layer 22 controls a viewing angle in the Y direction and the second louver layer 24 controls a viewing angle in the X direction, and therefore one sheet of the light transmission direction control sheet 20 can control viewing angles in two directions simultaneously.

A method for manufacturing the light transmission direction control sheet 20 is not particularly limited as long as being a method for laminating and integrating the louver layers 22 and 24 and the transparent resin layers 21, 23, and 25. For example, a material forming the first transparent resin layer 21 is applied onto the first surface of the first louver layer 22 and cured to form the first transparent resin layer 21. Thereafter, a curable material forming the third transparent resin layer 23 is applied onto the second surface of the first louver layer 22, the second louver layer 24 is placed on the coating film before the coating film is completely cured, and the coating film is cured. The third transparent resin layer 23 can be thereby formed, and the first louver layer 22 and the second louver layer 24 can be bonded to each other through the third transparent resin layer 23. Subsequently, similarly to the formation of the first transparent resin layer 21, the second transparent resin layer 25 is formed on the second surface of the second louver layer 24 to obtain the light transmission direction control sheet 20.

[Use of Light Transmission Direction Control Sheet]

By disposing the light transmission direction control sheet 10 near a display screen of an information display device so as to cover the display screen, so-called peeping can be prevented. Examples of a disposing method include a disposing method for bringing the outer surface 4a of the first transparent resin layer 4 or the outer surface 5a of the second transparent resin layer 5 of the light transmission direction control sheet 10 formed in a rectangular shape into close contact with a transparent substrate constituting a display screen of an information display device. The light transmission direction control sheet 10 may be disposed on an outer surface of the device while being exposed to the outside or may be disposed inside the device while being hardly recognized from the outside. In a case where the light transmission direction control sheet 10 is incorporated in the information display device, for example, preferably, the outer surface 4a of the first transparent resin layer 4 is fixed in close contact with the transparent substrate constituting the display screen inside the device, and the outer surface 5a of the second transparent resin layer 5 is fixed in close contact with the transparent substrate constituting an outer surface (a part of a casing) of the device. That is, the light transmission direction control sheet 10 is preferably disposed while being sandwiched in close contact between the two transparent substrates facing each other apart from each other included in the information display device. When the light transmission direction control sheet 10 is disposed in this way, no air layer is interposed between the two transparent substrates of the information display device and the transparent resin layers 4 and 5 of the light transmission direction control sheet 10, and therefore a decrease in light transmittance can be suppressed.

An extension direction of the light transmission band 2 (and the light-shielding band 3) of the disposed light transmission direction control sheet 10 and a side of a display screen frame may be parallel or non-parallel to each other. In order to prevent generation of moire fringes, the extension direction of the light transmission band 2 may be inclined with respect to the display screen frame (a bias angle may be added).

In the above, the case of the light transmission direction control sheet 10 has been described as a method using the light transmission direction control sheet according to an aspect of the present invention, but the light transmission direction control sheet 20 can also be used in a similar manner to the above.

### EXAMPLES

Examples will be described below, but the present invention is not limited to these Examples.

### Example 1

The light transmission direction control sheet 10 shown in FIG. 1 was manufactured.

First, as a material of the light transmission band 2, a first sheet having a thickness of 125 μm and formed of a transparent silicone rubber (manufactured by Shin-Etsu Chemical Co., Ltd., trade name: KE-153-U) having a refractive index of about 1.43 was prepared.

Apart from this, as a material of the light-shielding band 3, a second sheet having a thickness of 10 μm thickness and formed of a material obtained by adding 15 parts by mass of carbon black to 100 parts by mass of a transparent silicone rubber (manufactured by Shin-Etsu Chemical Co., Ltd., trade name: KE-153-U) was prepared.

A plurality of the first sheets and a plurality of the second sheets was alternately laminated, heated, vulcanized, and pressurized to form a block body in which the plurality of sheets is integrated.

By slicing the block body with a cut plane perpendicular to the sheets surface into a thickness of 310 μm, the louver layer 1 was manufactured.

A surface of the louver layer 1 was roughened due to slicing, and therefore irregular reflection of light occurred on the surface and the surface appeared cloudy. Therefore, it was difficult to see through the single louver layer 1, and it was impossible to visually confirm whether or not the light transmission band 2 and the light-shielding band 3 are regularly arranged.

Subsequently, a liquid silicone rubber (manufactured by Shin-Etsu Chemical Co., Ltd., trade name: KE-1987) having a refractive index of about 1.43 was applied onto a surface of a mirror finished PET film so as to have a thickness of about 20 μm using a screen printer, and this application surface was placed on the first surface of the louver layer 1, and was heated, vulcanized, and bonded. Thereafter, the PET film was peeled off to form the first transparent resin layer 4 formed of a silicone rubber. In a similar manner, the second transparent resin layer 5 formed of a silicone rubber was formed on the second surface of the louver layer 1 to obtain the light transmission direction control sheet 10.

The light transmission direction control sheet 10 before the PET film was peeled off was visually observed through the light transmission direction control sheet 10, the light transmission band 2 and the light-shielding band 3 constituting the louver layer 1 were regularly arranged, and it was easily confirmed that the light transmission direction control sheet 10 was a good product without defects.

When there was a defect, it was easily visually confirmed that black spots or voids were scattered irregularly.

The arithmetic average roughness (Ra) of an outer surface of each of the transparent resin layers 4 and 5 of the light transmission direction control sheet 10 obtained by peeling off the PET film was measured using a surface roughness tester (manufactured by Kosaka Laboratories, trade name: SE 600), and it was found that both the surfaces had Ra of 0.1 μm, and were smooth mirror surfaces equivalent to a mirror finished PET film surface.

The light-transmitting property of the light transmission direction control sheet 10 was measured using a haze meter (manufactured by Nippon Denshoku Industries Co., Ltd., trade name: NDH 2000), and the total light transmittance was 80%, and the haze was 3. Herein, the haze is determined by a formula “haze (%)=Td/Tt×100”. In the formula, Td represents diffuse transmittance, and Tt represents total light transmittance.

A viewing angle of the light transmission direction control sheet 10 was about 65° in a plane orthogonal to a longitudinal direction in which the light transmission band 2 and the light-shielding band 3 of the louver layer 1 were extended.

### Example 2

A light transmission direction control sheet 10′ was manufactured in a similar manner to Example 1 except that a rough surface processed PET film was used.

When the light transmission direction control sheet 10′ before the PET film was peeled off was visually observed through the light transmission direction control sheet 10′, the light transmission band 2 and the light-shielding band 3 constituting the louver layer 1 were regularly arranged, and it was easily confirmed that the light transmission direction control sheet 10′ was a good product without defects.

When there was a defect, it was easily visually confirmed that black spots or voids were scattered irregularly.

The arithmetic average roughness (Ra) of an outer surface of each of the transparent resin layers 4 and 5, the light-transmitting property, the haze, and the viewing angle of the light transmission direction control sheet 10′ in Example 2, obtained by peeling off the PET film were measured in a similar manner to Example 1, and Ra=2.6 μm, total light transmittance=73%, haze=41, and viewing angle=about 65° were obtained. The haze value was higher, and the total light transmittance was lower than those in Example 1.

### Example 3

A light transmission direction control sheet 10″ was manufactured in a similar manner to Example 1 except that a non-mirror finished PET film was used.

When the light transmission direction control sheet 10″ before the PET film was peeled off was visually observed through the light transmission direction control sheet 10″, the light transmission band 2 and the light-shielding band 3 constituting the louver layer 1 were regularly arranged, and it was easily confirmed that the light transmission direction control sheet 10″ was a good product without defects.

When there was a defect, it was easily visually confirmed that black spots or voids were scattered irregularly.

The arithmetic average roughness (Ra) of an outer surface of each of the transparent resin layers 4 and 5, the light-transmitting property, the haze, and the viewing angle of the light transmission direction control sheet 10″ in Example 3, obtained by peeling off the PET film were measured in a similar manner to Example 1, and Ra=0.2 μm, total light transmittance=78%, haze=6, and viewing angle=about 65° were obtained.

### Comparative Example 1

An epoxy adhesive (refractive index: about 1.55) having a thickness of 10 μm was applied onto each surface of the louver layer 1 manufactured in Example 1, and a polycarbonate film (refractive index: about 1.58) having outer surfaces thereof mirror finished and having a thickness of 30 μm was bonded thereto through an adhesive layer of each of the surfaces.

Through the above steps, a light transmission direction control sheet having adhesive layers and polycarbonate films on both surfaces of the louver layer 1 in Comparative Example 1 was obtained.

When the light transmission direction control sheet having polycarbonate films on both surfaces thereof was visually observed through the light transmission direction control sheet, the light transmission band 2 and the light-shielding band 3 constituting the louver layer 1 were regularly arranged, and it was easily confirmed that the light transmission direction control sheet was a good product without defects.

When there was a defect, it was easily visually confirmed that black spots or voids were scattered irregularly.

However, as indicated by the following results, optical characteristics were inferior to those of the light transmission direction control sheet 10 in Example 1. It is considered that this is because large interface reflection occurred at each interface among the louver layer 1, the adhesive layer, and the polycarbonate film.

The arithmetic average roughness (Ra) of an outer surface of each of the polycarbonate films, the light-transmitting property, the haze, and the viewing angle of the light transmission direction control sheet in Comparative Example 1 were measured in a similar manner to Example 1, and Ra=0.1 μm, total light transmittance=77%, haze=6, and viewing angle=about 65° were obtained.

The haze value was higher, and the total light transmittance was lower than those in Example 1.

### Comparative Example 2

A light transmission direction control sheet was manufactured in a similar manner to Comparative Example 1 except that a rough surface processed polycarbonate film (refractive index: about 1.58) was used.

When the light transmission direction control sheet having polycarbonate films on both surfaces thereof was visually observed through the light transmission direction control sheet, the light transmission band 2 and the light-shielding band 3 constituting the louver layer 1 were regularly arranged, and it was easily confirmed that the light transmission direction control sheet was a good product without defects.

When there was a defect, it was easily visually confirmed that black spots or voids were scattered irregularly.

However, as indicated by the results in Table 1, optical characteristics were inferior to those of the light transmission direction control sheet 10 in Example 1. It is considered that this is because large interface reflection occurred at each interface among the louver layer 1, the adhesive layer, and the polycarbonate film.

The results of Examples 1 to 3 and Comparative Examples 1 and 2 are excerpted below. In Table 1, “difference in refractive index” means a difference between the refractive index (1.43) of the light transmission band and the refractive index (1.43) of the first transparent resin layer in Examples, and a difference between the refractive index (1.43) of the light transmission band and the refractive index (1.55) of the epoxy adhesive in Comparative Examples. In addition, “Ra” means the arithmetic average roughness of an outer surface of the first transparent resin layer in Examples, and means the arithmetic average roughness of an outer surface of the polycarbonate film in Comparative Examples.

TABLE 1

| | Difference | | | |
|---|---|---|---|---|
| | in | | | |
| | refractive | | Total light | |
| | index | Ra (μm) | transmittance (%) | Haze |
| Example 1 | 0 | 0.1 | 80 | 3 |
| Example 2 | 0 | 2.6 | 73 | 41 |
| Example 3 | 0 | 0.2 | 78 | 6 |
| Comparative Example 1 | 0.12 | 0.1 | 77 | 6 |
| Comparative Example 2 | 0.12 | 2.2 | 71 | 38 |

From the results in Table 1, it is clear that the optical characteristics are better as the arithmetic average roughness Ra of the outer surface of the light transmission direction control sheet is lower. Furthermore, from the results of Example 1 and Comparative Example 1 in which Ra is the same, it is clear that a difference in refractive index of less than 0.1 improves the optical characteristics.

The present invention has been described with reference to specific Examples, but it is needless to say that the technical scope of the present invention is not limited to the scope described in the above Examples. It is obvious to those skilled in the art that various modifications or improvements can be added to the above Examples. In addition, it is obvious from the description of the claims that a form obtained by adding such modifications or improvements is also included in the technical scope of the present invention.

The light transmission direction control sheet according to an aspect of the present invention can be used as a sheet for preventing peeping by disposing the light transmission direction control sheet on a display screen of various information display devices, or can be used as an optical filter by attaching the light transmission direction control sheet to a lighting device or a sensor device.

### REFERENCE SIGNS LIST

1 Louver layer
2 Light transmission band
3 Light-shielding band
4 First transparent resin layer
4a Outer surface of first transparent resin layer
5 Second transparent resin layer
5a Outer surface of second transparent resin layer
10 Light transmission direction control sheet
20 Light transmission direction control sheet
21 First transparent resin layer
22 First louver layer
23 Third transparent resin layer
24 Second louver layer
25 Second transparent resin layer
26 Light transmission band
27 Light-shielding band
28 Light transmission band
29 Light-shielding band

What is claimed is:

1. A light transmission direction control sheet comprising: a louver layer having a light transmission band and a light-shielding band alternately and repeatedly disposed; a first transparent resin layer disposed on a first surface of the louver layer; and a second transparent resin layer disposed on a second surface of the louver layer, wherein
each of a difference between a refractive index of the light transmission band and a refractive index of the first transparent resin layer, and a difference between the refractive index of the light transmission band and a refractive index of the second transparent resin layer, is less than 0.1.

2. The light transmission direction control sheet according to claim 1, wherein an arithmetic average roughness (Ra) of at least one outer surface of the first transparent resin layer and the second transparent resin layer is 0 μm to 3.0 μm.

3. The light transmission direction control sheet according to claim 1, wherein the light transmission band, the first transparent resin layer, and the second transparent resin layer are formed of a silicone rubber.

4. The light transmission direction control sheet according to claim 2, wherein the light transmission band, the first transparent resin layer, and the second transparent resin layer are formed of a silicone rubber.

5. The light transmission direction control sheet according to any one of claims 1 to 4, wherein a thickness of the louver layer is 150 μm to 500 μm, a thickness of the first transparent resin layer is 10 μm to 20 μm, and a thickness of the second transparent resin layer is 10 μm to 20 μm.
